(19) United States
(12) Patent Application Publication
(10) Pub. No.: US 2019/0246852 A1
(43) Pub. Date: Aug. 15, 2019

(54) ROBOTIC CLEANING DEVICE AND A METHOD OF CONTROLLING MOVEMENT OF THE ROBOTIC CLEANING DEVICE

(71) Applicant: Aktiebolaget Electrolux, Stockholm (SE)

(72) Inventors: Andreas Klintemyr, Stockholm (SE); Niklas Nordin, Stockholm (SE)

(21) Appl. No.: 16/333,336

(22) PCT Filed: Sep. 20, 2016
(86) PCT No.: PCT/EP2016/072291

§ 371 Date: Mar. 14, 2019

(51) Int. Cl. A47L 9/00; A47L 9/28; G05D 1/00; G05D 1/02

(52) U.S. Cl. CPC A47L 9/009; A47L 9/2852; A47L 9/2826; G05D 1/0088; G05D 2201/0215; G05D 1/0248; A47L 2201/04; G05D 2201/0203; G05D 1/0227

(57) ABSTRACT

A method of controlling movement of a robotic cleaning device is provided. The method comprises determining a path to be traversed by robotic cleaning device and controlling movement of the robotic cleaning device along the path. The method further comprises determining whether the movement along the path does not comply with an expected movement, and if so terminating the movement along the path. A robotic cleaning device is also provided.

### TECHNICAL FIELD

The invention relates to a robotic cleaning device and a method of controlling movement of the robotic cleaning device.

### BACKGROUND

In many fields of technology, it is desirable to use robots with an autonomous behaviour such that they freely can move around a space without colliding with possible obstacles.

Robotic vacuum cleaners are known in the art, which are equipped with drive means in the form of a motor for moving the cleaner across a surface to be cleaned. The robotic vacuum cleaners are further equipped with intelligence in the form of microprocessor(s) and navigation means for causing an autonomous behaviour such that the robotic vacuum cleaners freely can move around and clean a surface in the form of e.g. a floor. Thus, these prior art robotic vacuum cleaners have the capability of more or less autonomously vacuum clean a room in which objects such as tables and chairs and other obstacles such as walls and stairs are located.

A problem in the art is that the robotic cleaners may navigate incorrectly and as a consequence set out on path which is not correct. Since the robotic cleaner is unaware that it actually travels an incorrect path, it may continue along the incorrect path for an indefinite—and potentially long—time without correcting its behaviour.

### SUMMARY

An object of the present invention is to solve, or at least mitigate, this problem in the art and to provide an improved method of controlling movement of a robotic cleaning device.

This object is attained in a first aspect of the present invention by a method of controlling movement of a robotic cleaning device. The method comprises determining a path to be traversed by robotic cleaning device and controlling movement of the robotic cleaning device along the path. The method further comprises determining whether the movement along the path does not comply with an expected movement, and if so terminating the movement along the path.

This object is attained in a second aspect of the present invention by a robotic cleaning device comprising a propulsion system configured to move the robotic cleaning device over a surface to be cleaned, and at least one obstacle detecting device configured to detect objects in a vicinity of the robotic cleaning device. The robotic cleaning device further comprises a controller configured to control the propulsion system to move the robotic cleaning device and to acquire information from the at least one obstacle detecting device regarding detected objects. The controller is further configured to determine a path to be traversed by the robotic cleaning device, control movement of the robotic cleaning device along the path, determine whether the movement along the path does not comply with an expected movement, and if so terminate the movement along the path.

Advantageously, by determining whether movement of the robotic cleaning device along path which it has set out to follow does not comply with an expected movement—e.g. the robotic cleaning device has moved for a certain distance or time period without having encountered an object—and if so terminating the movement along the path, incorrect navigation can be swiftly attended to.

The robotic cleaning device is equipped with one or more obstacle detection devices, such as a bumper, infrared (IR) sensors and/or sonar sensors, microwave radar, or even a 3D sensor system registering its surroundings, implemented by means of e.g. a 3D camera, a camera in combination with lasers, a laser scanner, etc.

In an embodiment, the movement along the path is considered not to comply with an expected movement if the robotic cleaning device has travelled along the path for a certain distance. Hence, if the travelled distance exceeds a threshold distance value, further travel along the path is terminated.

In another embodiment, the movement along the path is considered not to comply with an expected movement if the robotic cleaning device has travelled along the path for a certain time period. Hence, if the time period exceeds a threshold time value, further travel along the path is terminated.

In yet another embodiment, the movement along the path is considered not to comply with an expected movement if the robotic cleaning device has rotated a certain angle. Hence, if the angle of rotation exceeds a threshold angle value, further travel along the path is terminated.

In still a further embodiment, the robotic cleaning device provides an alert to a user that the movement along the path is terminated, such as an audible or visual indication.

In still another embodiment, a representation of an environment of the robotic cleaning device is created based on sensor input, such an input from the obstacle detection device(s); wherein the path to be traversed by the robotic cleaning device is determined on the basis of the created representation.

In yet a further embodiment, the representation is created from objects detected in a vicinity of the robotic cleaning device.

Further embodiments of the present invention will be described in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a view of a robotic cleaning device according to an embodiment;

FIG. 2 illustrates a potentially desired movement pattern of the robotic cleaning device of FIG. 1;

FIG. 3a illustrates a scenario where controlling of the movement of the robotic cleaning device according to an embodiment is applied;

FIG. 3b shows a flowchart of a method of controlling the movement of the robot according to an embodiment in the scenario of FIG. 3a;

FIG. 4a illustrates a further scenario where controlling of the movement of the robotic cleaning device according to an embodiment is applied;

FIG. 4b shows a flowchart of a method of controlling the movement of the robot according to an embodiment in the scenario of FIG. 4a;

FIG. 5a illustrates yet a further scenario where controlling of the movement of the robotic cleaning device according to an embodiment is applied;

FIG. 5b shows a flowchart of a method of controlling the movement of the robot according to an embodiment in the scenario of FIG. 5a; and

FIG. 6 shows a view of a robotic cleaning device according to another embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

The invention relates to robotic cleaning devices, or in other words, to automatic, self-propelled machines for cleaning a surface, e.g. a robotic vacuum cleaner, a robotic sweeper or a robotic floor washer. The robotic cleaning device according to the invention can be mains-operated and have a cord, be battery-operated or use any other kind of suitable energy source, for example solar energy.

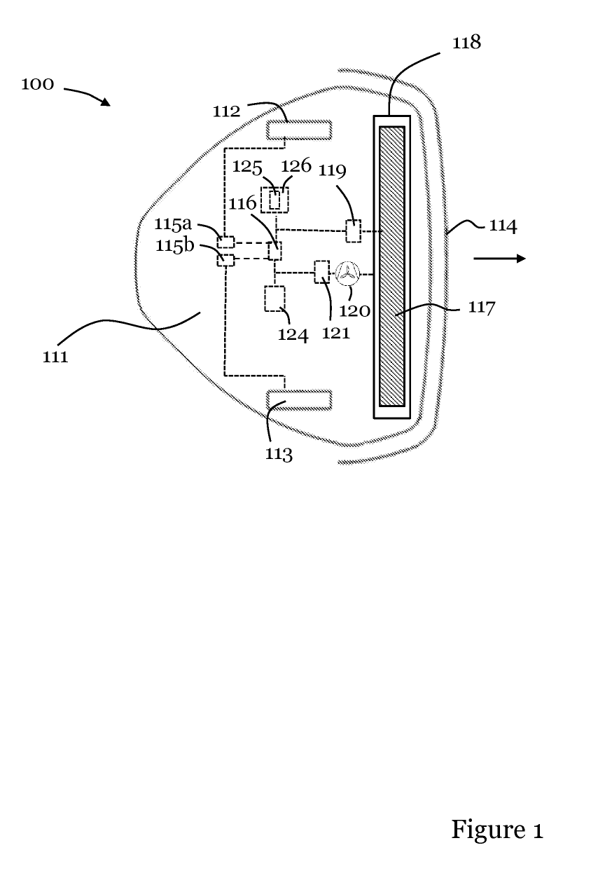

Even though it is envisaged that the invention may be performed by any appropriate robotic cleaning device being equipped with sufficient processing intelligence, FIG. 1 shows a robotic cleaning device 100 according to an embodiment of the present invention in a bottom view, i.e. the bottom side of the robotic cleaning device is shown. The arrow indicates the forward direction of the robotic cleaning device 100 being illustrated in the form of a robotic vacuum cleaner.

The robotic cleaning device 100 comprises a main body 11 housing components such as a propulsion system comprising driving means in the form of two electric wheel motors 115a, 115b for enabling movement of the driving wheels 112, 113 such that the cleaning device can be moved over a surface to be cleaned. Each wheel motor 115a, 115b is capable of controlling the respective driving wheel 112, 113 to rotate independently of each other in order to move the robotic cleaning device 100 across the surface to be cleaned. A number of different driving wheel arrangements, as well as various wheel motor arrangements, can be envisaged. It should be noted that the robotic cleaning device may have any appropriate shape, such as a device having a more traditional circular-shaped main body, or a triangular-shaped main body. As an alternative, a track propulsion system may be used or even a hovercraft propulsion system. The propulsion system may further be arranged to cause the robotic cleaning device 100 to perform any one or more of a yaw, pitch, translation or roll movement.

A controller 116 such as a microprocessor controls the wheel motors 115a, 115b to rotate the driving wheels 112, 113 as required in view of information received from an obstacle detecting device for detecting obstacles in the form of walls, floor lamps, table legs, around which the robotic cleaning device must navigate.

In the exemplifying embodiment of FIG. 1, the obstacle detecting device is implemented in the form of a bumper 114. For illustrative purposes, the distance between the bumper 114 and a front end portion of the main body 111 is somewhat exaggerated; in practice the bumper 119 is arranged flush against the front end portion.

When the robotic cleaning device 100 moves forward and bumps into an obstacle, contact with the obstacle is detected by the bumper 114, which is flexibly mounted to the front end portion of the main body 111. Since the bumper 114 is flexible, it will press resiliently against the front end portion of the body 111 when contacting obstacles, thus mitigating the thrusting effect it has on obstacles in its way and reducing the risk that the obstacles will be displaced, tipped over and/or be damaged.

The microprocessor 116 registers pressing of the bumper 114 against the main body 111 and hence detects contact with an obstacle, in order to control the motors 115a, 115b to rotate the driving wheels 112, 113 thereby controlling movement of the robotic cleaning device 100 as required accordingly.

It is noted that other more complex obstacle detecting devices are envisaged, such as infrared (IR) sensors and/or sonar sensors, microwave radar, or even a vision based sensor system in the form of a 3D sensor system registering its surroundings, implemented by means of e.g. a 3D camera, a camera in combination with lasers, a laser scanner, etc. for detecting obstacles and communicating information about any detected obstacle to the microprocessor 116. The microprocessor 116 communicates with the wheel motors 115a, 115b to control movement of the wheels 112, 113 in accordance with information provided by the obstacle detecting device such that the robotic cleaning device 100 can move as desired across the surface to be cleaned. A combination of various obstacle detecting devices is further envisaged.

Further, the main body 111 may optionally be arranged with a cleaning member 117 for removing debris and dust from the surface to be cleaned in the form of a rotatable brush roll arranged in an opening 118 at the bottom of the robotic cleaner 100. Thus, the rotatable brush roll 117 is arranged along a horizontal axis in the opening 118 to enhance the dust and debris collecting properties of the cleaning device 100. In order to rotate the brush roll 117, a brush roll motor 119 is operatively coupled to the brush roll to control its rotation in line with instructions received from the controller 116.

Moreover, the main body 111 of the robotic cleaner 100 comprises a suction fan 120 creating an air flow for transporting debris to a dust compartment, a dust bag or cyclone arrangement (not shown) housed in the main body via the opening 118 in the bottom side of the main body 111. The suction fan 120 is driven by a fan motor 121 communicatively connected to the controller 116 from which the fan motor 121 receives instructions for controlling the suction fan 120. It should be noted that a robotic cleaning device having either one of the rotatable brush roll 117 and the suction fan 120 for transporting debris to the dust bag can be envisaged. A combination of the two will however enhance the debris-removing capabilities of the robotic cleaning device 100.

The robotic cleaning device 100 may further be arranged with one or more side brushes (not shown) for further improving the removal of dust and debris from the surface over which the robotic cleaning device 100 moves.

The main body 111 or the robotic cleaning device 100 may further be equipped with an inertia measurement unit (IMU) 124, such as e.g. a gyroscope and/or an accelerometer and/or a magnetometer or any other appropriate device for measuring displacement of the robotic cleaning device 100 with respect to a reference position, in the form of e.g. orientation, rotational velocity, gravitational forces, etc. The robotic cleaning device 100 may further comprise encoders (not shown in FIG. 1) on each drive wheel 112, 113 which generate pulses when the wheels turn. The encoders may for instance be magnetic or optical. By counting the pulses at the controller 116, the speed of each wheel 112, 113 can be determined, and the controller 116 can perform so called dead reckoning to determine position and heading of the cleaning device 100.

With further reference to FIG. 1, the controller/processing unit 116 embodied in the form of one or more microprocessors is arranged to execute a computer program 125 downloaded to a suitable storage medium 126 associated with the microprocessor, such as a Random Access Memory (RM), a Flash memory or a hard disk drive. The controller 116 is arranged to carry out a method according to embodiments of the present invention when the appropriate computer program 125 comprising computer-executable instructions is downloaded to the storage medium 126 and executed by the controller 116. The storage medium 126 may also be a computer program product comprising the computer program 125. Alternatively, the computer program 125 may be transferred to the storage medium 126 by means of a suitable computer program product, such as a digital versatile disc (DVD), compact disc (CD) or a memory stick. As a further alternative, the computer program 125 may be downloaded to the storage medium 126 over a wired or wireless network. The controller 116 may alternatively be embodied in the form of a digital signal processor (DSP), an application specific integrated circuit (ASIC), a field-programmable gate array (FPGA), a complex programmable logic device (CPLD), etc.

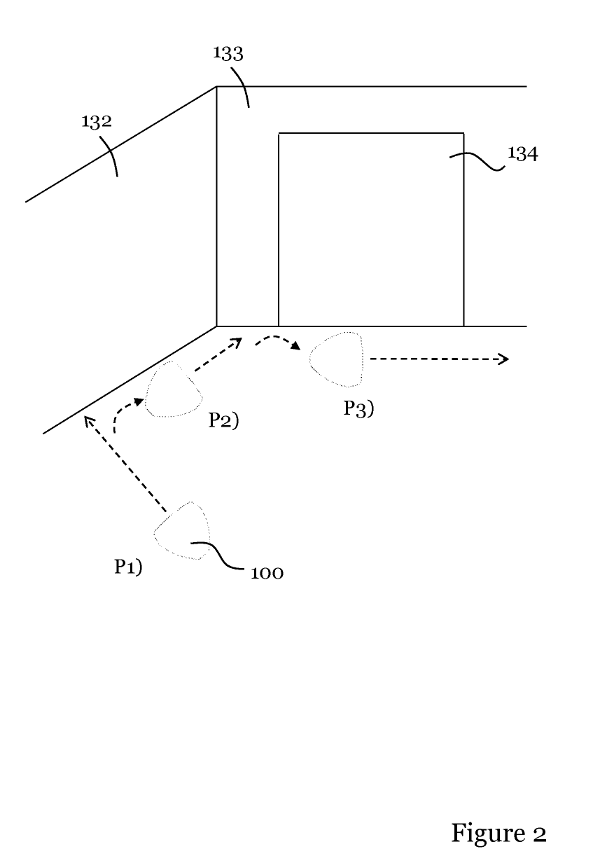

FIG. 2 illustrates a potentially desired movement pattern of the robotic cleaning device 100 of FIG. 1 (the robot may assumed many different movement patterns depending on in which cleaning mode it operates).

Now, assuming that the robot 100 commences a cleaning programme at position P1; in this particular cleaning programme, the robot 100 is configured to move straight ahead until it encounters an obstacle, preferably first wall 132.

When contacting the first wall 132, the robot 100 is controlled by the controller 116 to rotate appropriately and traverse along a path as determined by the controller 116, which in this example is the path following the first wall 132 as illustrated in position P2 until it encounters next obstacle, in this example second wall 133, where it again will rotate appropriately and follow the second wall 133 as illustrated in position P3, passing by door opening 134, until it encounters next obstacle, and so on.

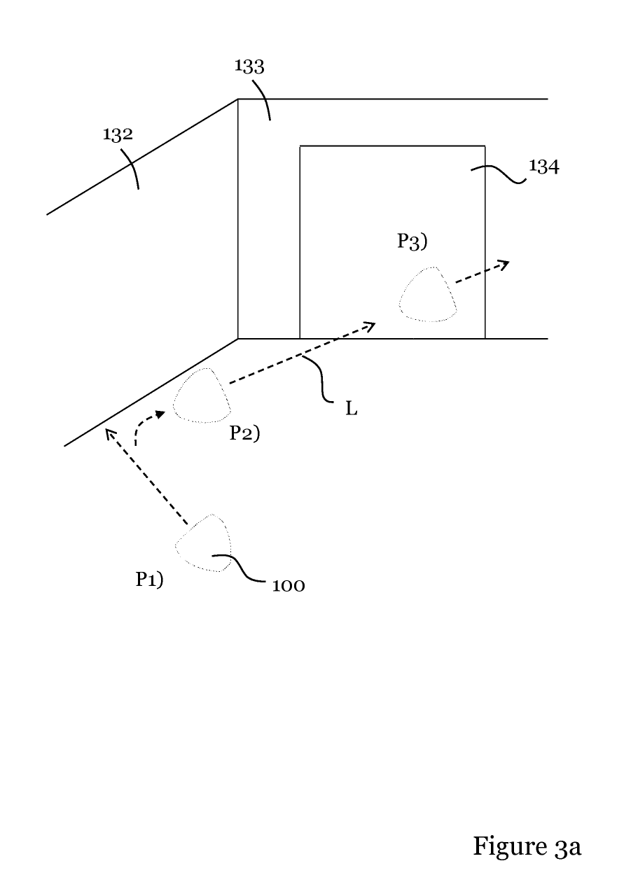

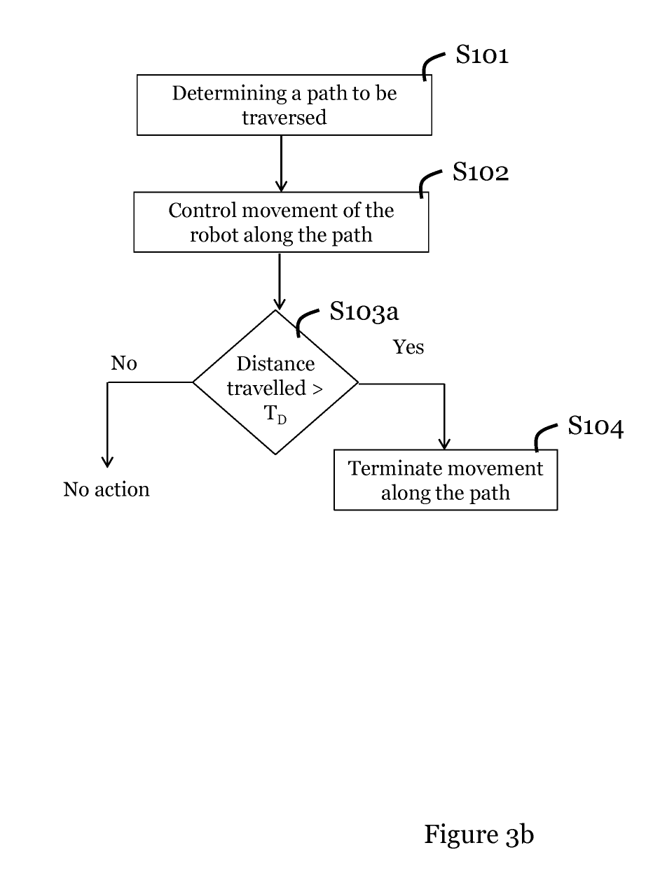

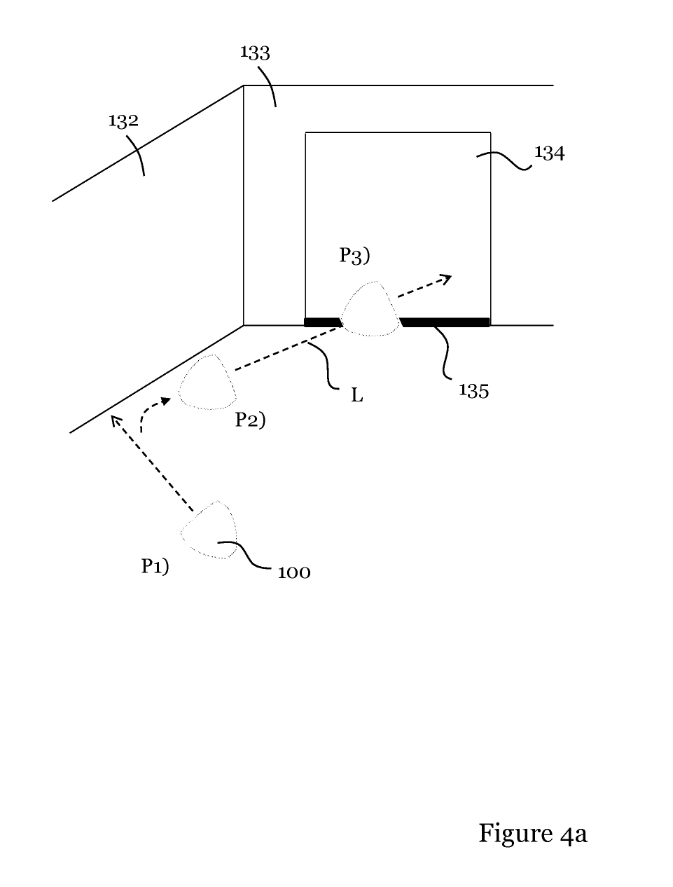

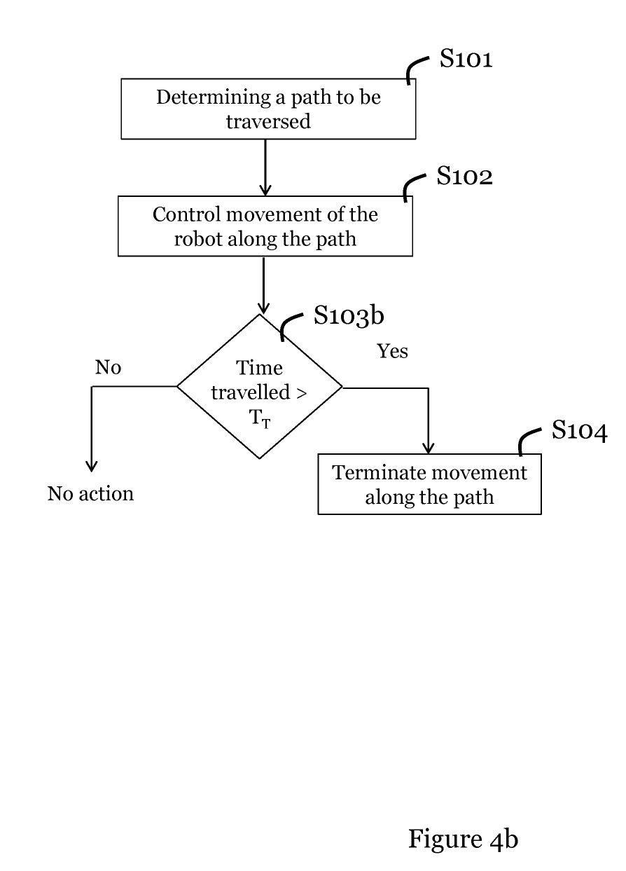

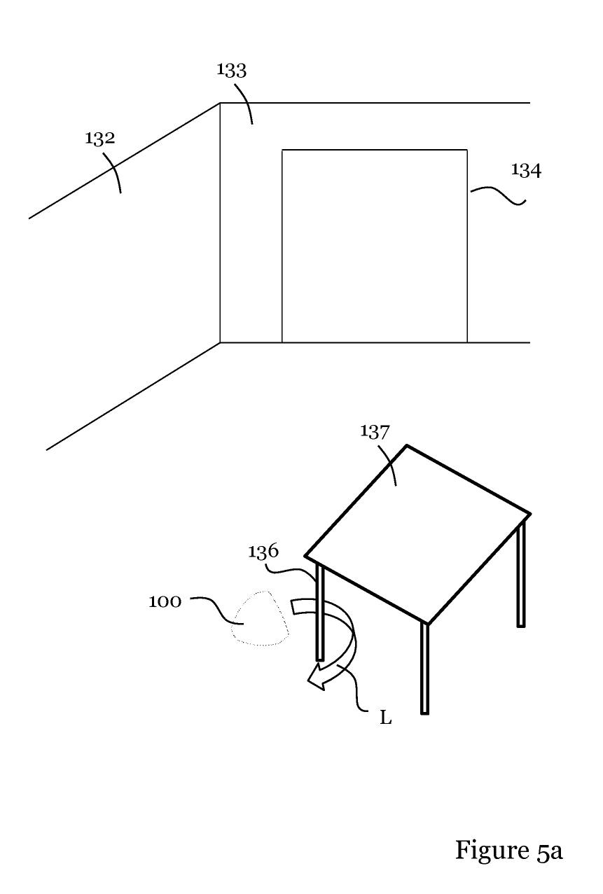

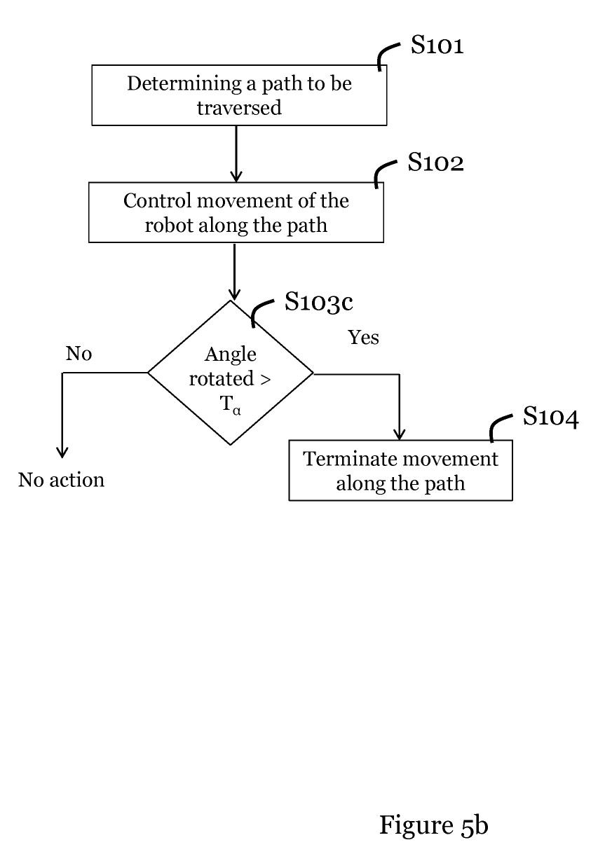

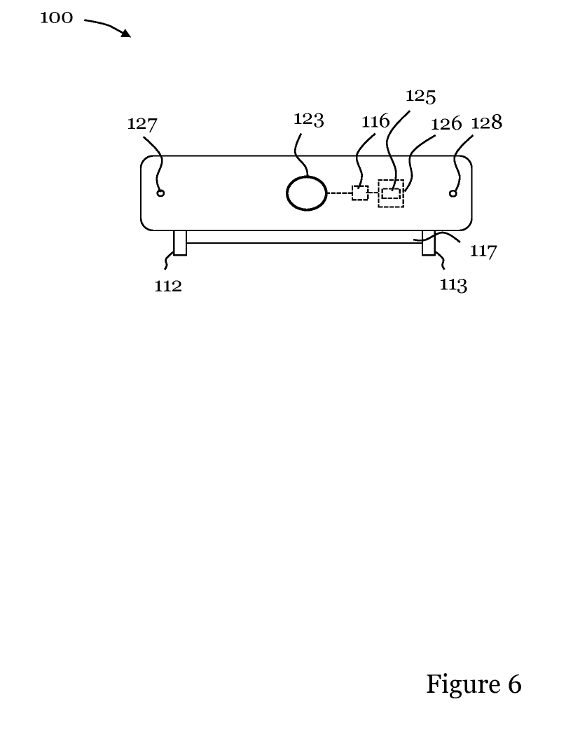

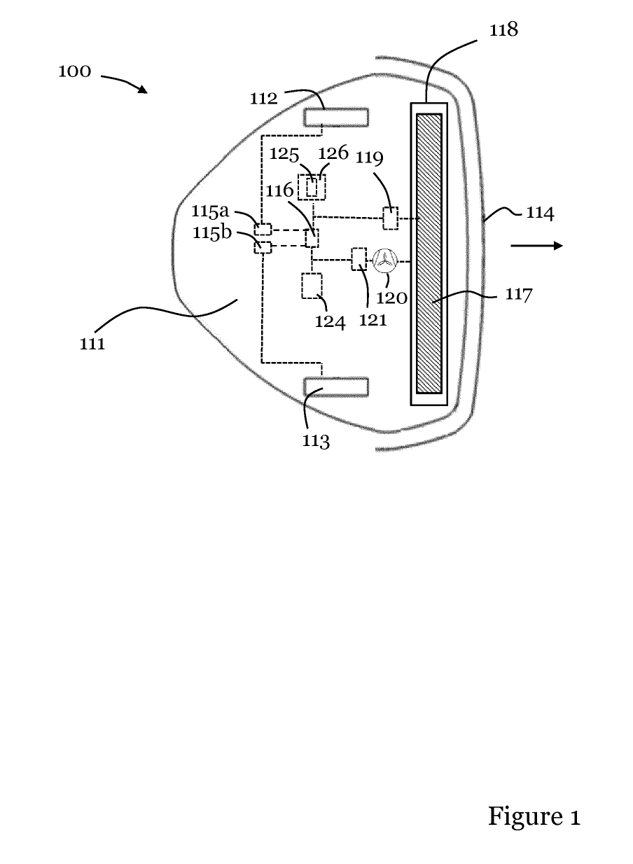

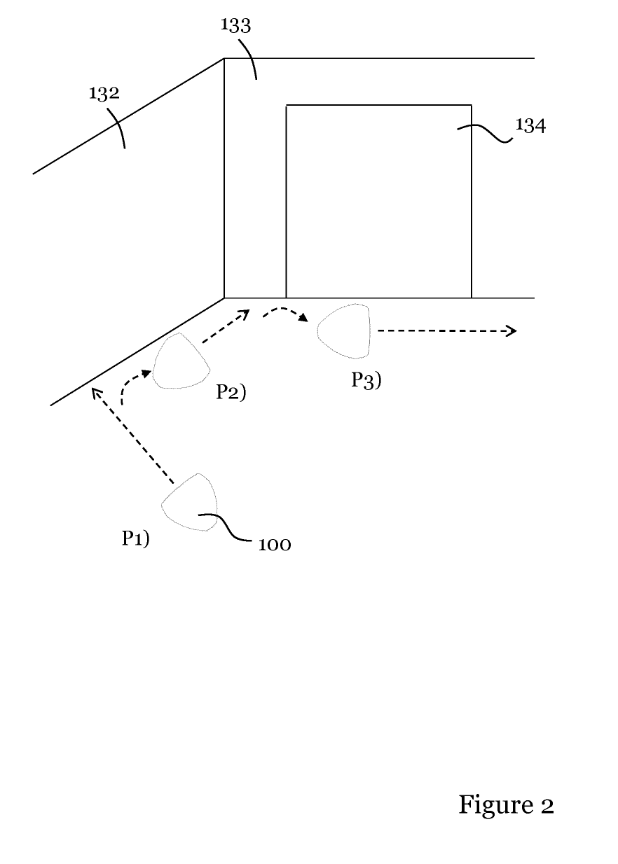

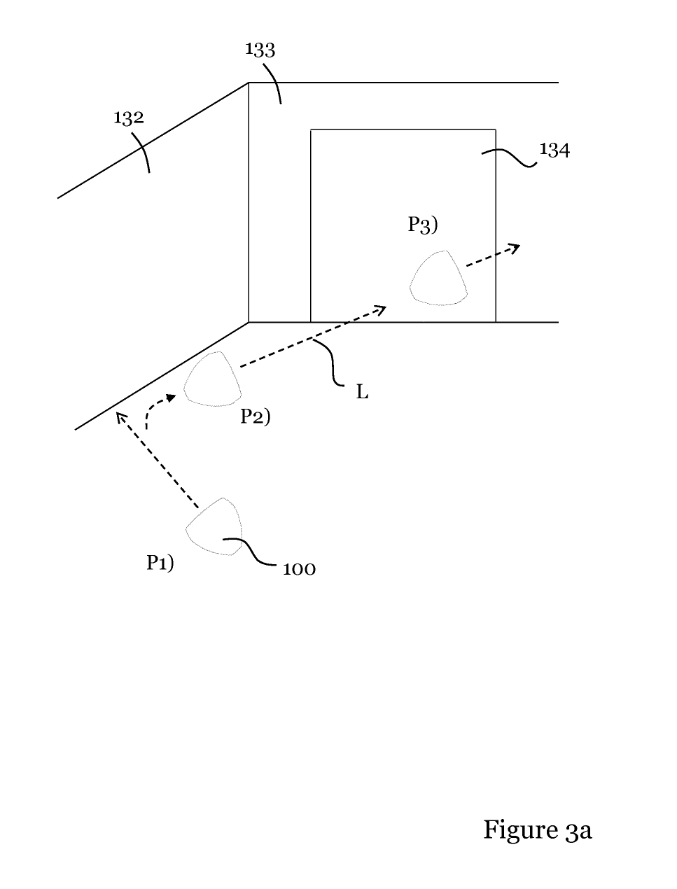

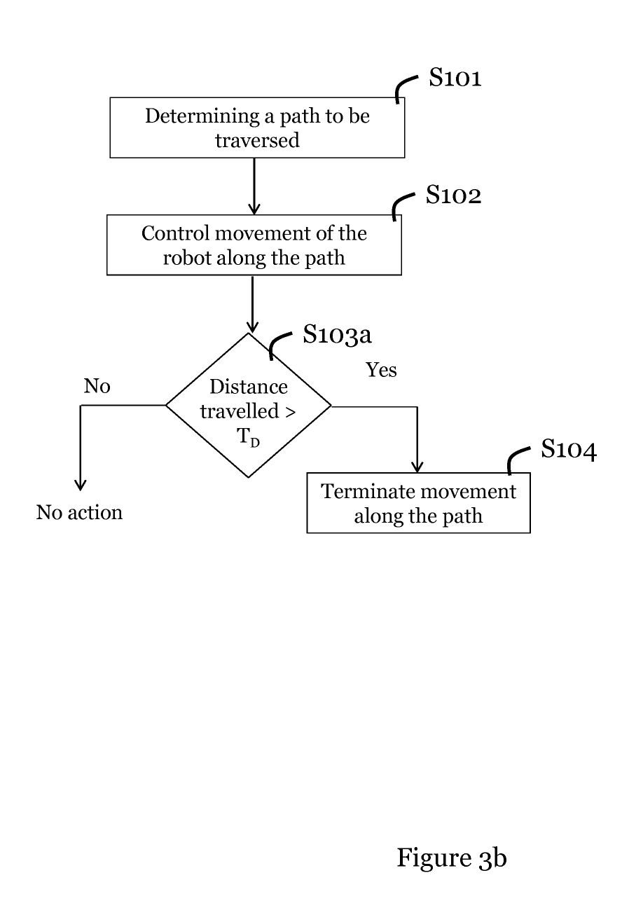

FIG. 3a illustrates a scenario where controlling of the movement of the robot 100 according to an embodiment advantageously is applied, while FIG. 3b shows a flowchart of a method of controlling the movement of the robot 1000 according to an embodiment.

As in FIG. 2, the robot 100 moves in a “bump mode”; when contacting the first wall 132, the robot 100 is controlled by the controller 16 to rotate appropriately, and follow the first wall 132. However, in this particular scenario, the robot 100 rotates slightly too much.

Again, the controller 116 determines a path—denoted L in FIG. 3a—to be traversed by robot 100 in step S101, and controls the movement of the robot along this path; in this example, the controller 116 will control the robot 100 to move straight ahead along the path L.

Since the robot 100 rotated slightly too much in a clockwise direction upon contacting the first wall 132, it will not follow the first wall 132 at position P2, but move along the path L and through the door opening 134 into the next room as illustrated at position P3.

According to the invention, the controller 116 of the robot 100 will advantageously determine whether the movement along the path L complies with an expected movement or not.

In this embodiment, the determining whether the movement along the path L complies with an expected movement or not comprises determining, in step S103a, whether the robotic cleaning device has travelled along said path for a determined distance.

Thus, in step S103a, if the travelled distance along path L exceeds at threshold distance value T_{D}, the controller 116 will terminate the movement of the robot 100 along the path L, as this indicates that the navigation appears to be erroneous.

As an example, if the robot still travels along the path L after having travelled for, say, 5 m, the controller 116 terminates the movement in step S104.

The threshold distance value T_{D} which in this particular example is set to 5 m typically depends on the environment in which the robot is intended to move. In this example, the rooms in which the robot moves have a size implying that the robot 100 should approach an obstacle after having travelled 5 m (in any direction). If not, a conclusion is drawn by the controller 116 that the robot 100 is not moving as expected. In a further embodiment, it may be envisaged that the threshold distance T_{D} is selected for each determined path L and even combined with other travel restrictions. Hence, a first determined path may be travelled “in a northbound direction until a wall is encountered but not further than 3 m”, while a second determined path may be travelled “in a westbound direction until a wall is encountered but not further than 5 nm”, and so on.

In contrast, if the robot 100 encounters an obstacle after having travelled e.g. 2 m along the path L, the controller 116 will receive an indication accordingly from the bumper 114 and select a new path which the robot 100 is to traverse, where the selection of the new path depends how the robot is configured to move according to the currently executed cleaning programme.

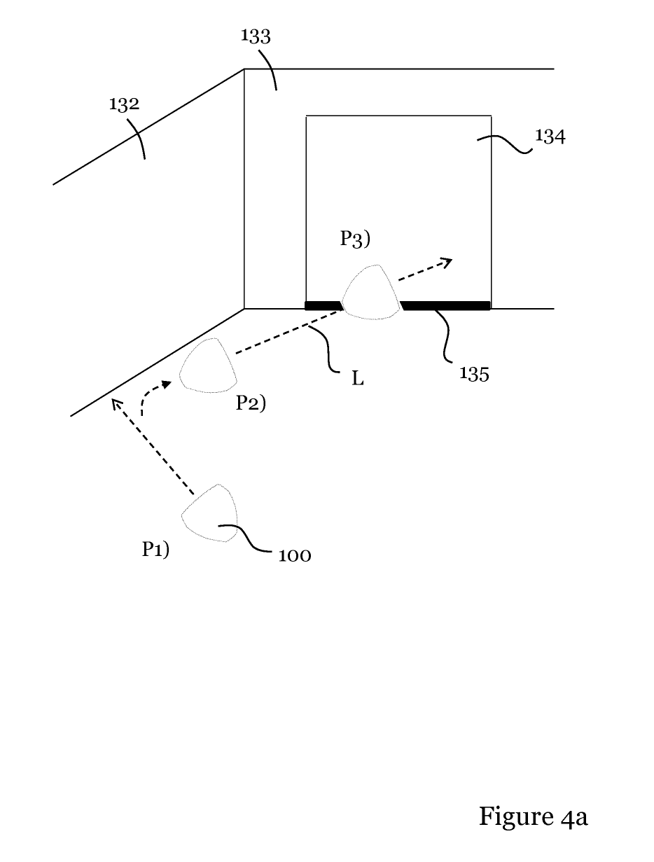

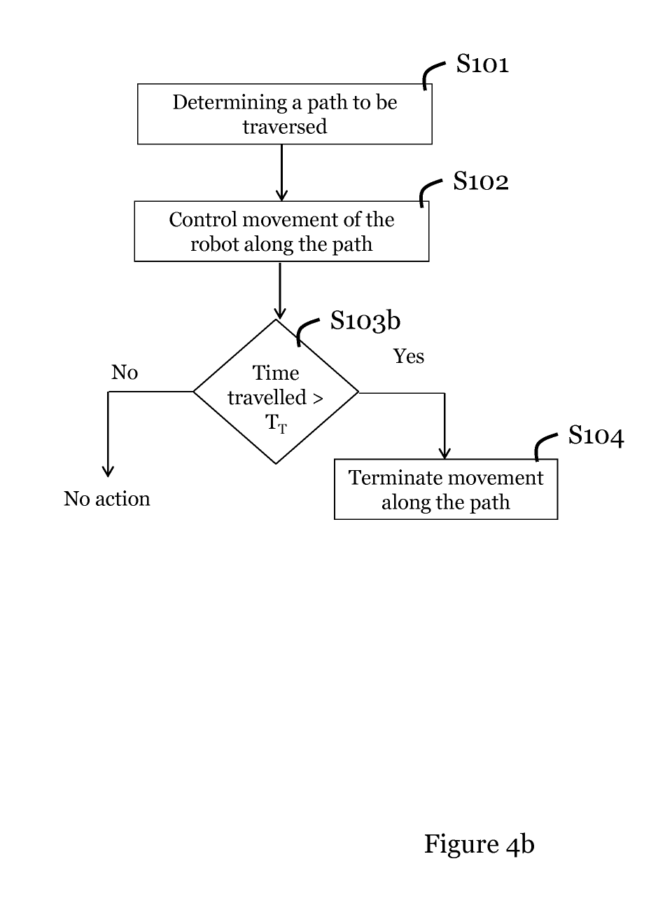

FIG. 4a illustrates another scenario where controlling of the movement of the robot 100 according to another embodiment advantageously is applied, while FIG. 4b shows a flowchart of a method of controlling the movement of the robot 100 according to this embodiment.

As previously, the robot 100 moves in a bump mode; when contacting the first wall 132, the robot 100 is controlled by the controller 116 to rotate appropriately, and follow the first wall 132. Again, the robot 100 rotates slightly too much, and the controller 116 determines the path L to be traversed by robot 100 in step S101, and further controls the movement of the robot straight along the path L.

As in FIG. 3a, since the robot 100 rotated slightly too much in a clockwise direction upon contacting the first wall 132, it will not follow the first wall 132 at position P2, but move along the path L towards the door opening 134 to the next room.

In this scenario, the robot 100 gets stuck on doorstep 135 at position P3. The wheels 112,113 of the robot 100 may still be moving—slipping against the doorstep 135—so the robot still believes it is moving forward, travelling along the path L.

In this embodiment, the determining whether the movement along the path L complies with an expected movement or not comprises determining, in step S103b, whether the robotic cleaning device has travelled along said path for a determined time period.

Thus, in step S103b, if the travelled distance along path L exceeds at threshold time value T_{T}, the controller 116 will terminate the movement of the robot 100 along the path L, as this indicates that the navigation appears to be erroneous.

As an example, if the robot still travels along the path L after having travelled for, say, 10 s, the controller 116 terminates the movement.

The threshold time value T_{T} which in this particular example is set to 10 s typically depends on the environment in which the robot is intended to move. In this example, the rooms in which the robot moves have a size implying that the robot 100 should approach an obstacle after having travelled 10 s (in any direction). If not, a conclusion is drawn by the controller 116 that the robot 100 is not moving as expected.

In contrast, if the robot 100 encounters an obstacle after having travelled e.g. 5 s along the path L, the controller 116 will receive an indication accordingly from the bumper 114 and select a new path which the robot 100 is to traverse, where the selection of the new path depends how the robot is configured to move according to the currently executed cleaning programme.

In an embodiment, the robot 100 indicates to a user that the movement has been terminated, for instance by a sound alert or a visual indication. Thus, the robot 100 may be equipped with a speaker and/or a display. Advantageously, the user can lift the robot 100 off of the doorstep 135 and the selected cleaning programme can be continued.

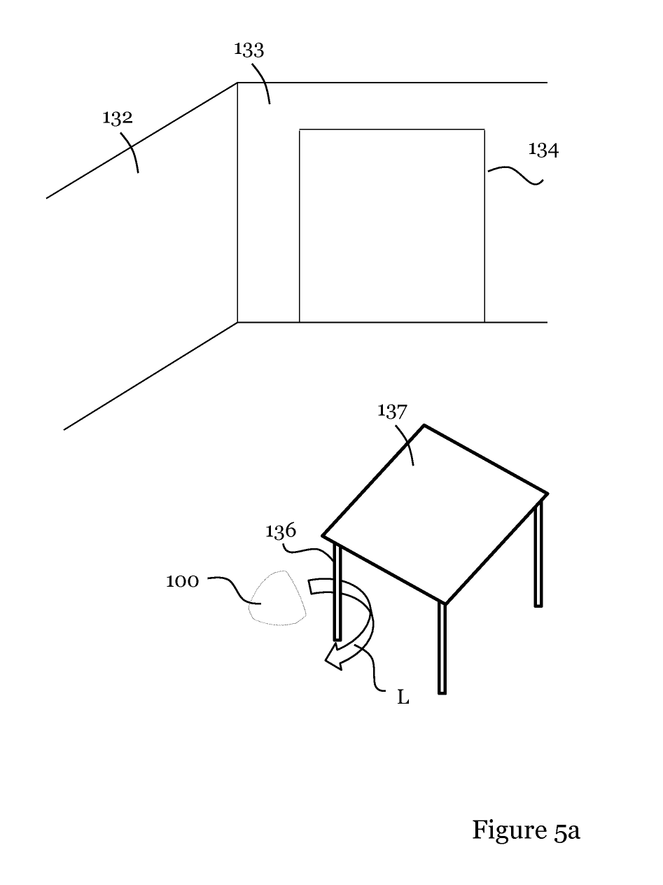

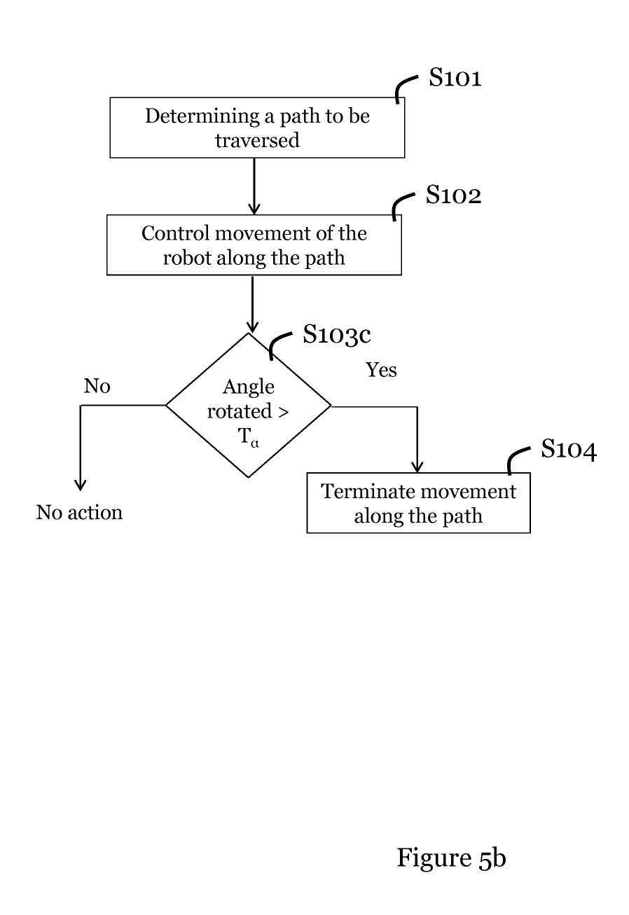

FIG. 5a illustrates yet another scenario where controlling of the movement of the robot 100 according to yet another embodiment advantageously is applied, while FIG. 5b shows a flowchart of a method of controlling the movement of the robot 100 according to this embodiment.

As previously, the robot 100 moves in a bump mode. In this scenario, the robot 100 encounters leg 136 of table 137.

In this case, it may be desirable that the robot 100 tries to track the periphery of the leg 136 to accurately clean the surface under the table 137.

Accordingly, the controller 116 determines the path L to be traversed by robot 100 in step S101, and further controls the movement of the robot along the path. L, which in this embodiment implies a circular path around the table leg 136.

Upon performing such circular movement, there is a risk that the robot 100 continues the movement for an indefinite time period since it does not bump against an obstacle during the process of performing the circular movement.

To overcome this problem, the determining whether the movement along the path L complies with an expected movement or not comprises determining—in step S103c—whether the robotic cleaning device has rotated a determined angle.

Thus, in step S103c, if the rotation around the leg 136 exceeds at threshold angle value T_{α}, the controller 116 will terminate the movement of the robot 100 along the path L, as this indicates that the navigation appears to be erroneous.

As an example, if the robot still follows the rotating path L after having rotated a full 360° around the leg 136, the controller 116 terminates the movement.

The threshold angle value T_{α} is in this particular example set to 360°, but other values can be envisaged depending on application.

In contrast, if the robot 100 encounters the leg 136 after having rotated e.g. 180° around the leg 136 along the path L, the controller 116 will receive an indication accordingly from the bumper 114 and may select a new path which the robot 100 is to traverse, where the selection of the new path depends how the robot is configured to move according to the currently executed cleaning programme.

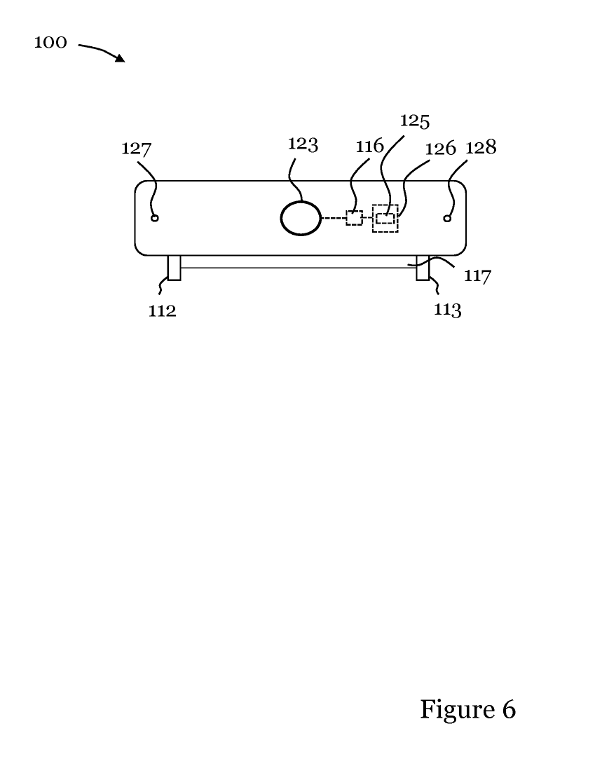

FIG. 6 shows a front view of a more complex version of the robotic cleaning device 100 of FIG. 1, which may or may not comprise the bumper 114, according to an embodiment.

In this embodiment, the previously mentioned obstacle detecting device is implemented in the form of a 3D sensor system comprising at least a camera 123 and a first and a second line laser 127, 128, which may be horizontally or vertically oriented line lasers.

Further shown is the controller 116, the main body 111, the driving wheels 112, 113, and the rotatable brush roll 117 previously discussed with reference to FIG. 1. The controller 116 is operatively coupled to the camera 123 for recording images of a vicinity of the robotic cleaning device 100. The first and second line lasers 127, 128 may preferably be vertical line lasers and are arranged lateral of the camera 123 and configured to illuminate a height and a width that is greater than the height and width of the robotic cleaning device 100. Further, the angle of the field of view of the camera 123 preferably smaller than the space illuminated by the first and second line lasers 127, 128. The camera 123 is controlled by the controller 116 to capture and record a plurality of images per second. Data from the images is extracted by the controller 116 and the data is typically saved in the memory 126 along with the computer program 125.

The first and second line lasers 127, 128 are typically arranged on a respective side of the camera 123 along an axis being perpendicular to an optical axis of the camera. Further, the line lasers 127, 128 are directed such that their respective laser beams intersect within the field of view of the camera 123. Typically, the intersection coincides with the optical axis of the camera 123.

The first and second line laser 127, 128 are configured to scan, preferably in a vertical orientation, the vicinity of the robotic cleaning device 100, normally in the direction of movement of the robotic cleaning device 100. The first and second line lasers 127, 128 are configured to send out laser beams, which illuminate furniture, walls and other objects of e.g. a room to be cleaned. The camera 123 is controlled by the controller 116 to capture and record images from which the controller 116 creates a representation or layout of the surroundings that the robotic cleaning device 100 is operating in, by extracting features from the images and by measuring the distance covered by the robotic cleaning device 100, while the robotic cleaning device 100 is moving across the surface to be cleaned. Thus, the controller 116 derives positional data of the robotic cleaning device 100 with respect to the surface to be cleaned from the recorded images, generates a 3D representation of the surroundings from the derived positional data and controls the driving motors 115a, 115b to move the robotic cleaning device across the surface to be cleaned in accordance with the generated 3D representation and navigation information supplied to the robotic cleaning device 100 such that the surface to be cleaned can be navigated by taking into account the generated 3D representation. Since the derived positional data will serve as a foundation for the navigation of the robotic cleaning device, it is important that the positioning is correct; the robotic device will otherwise navigate according to a “map” of its surroundings that is misleading.

The 3D representation generated from the images recorded by the 3D sensor system thus facilitates detection of obstacles in the form of walls, floor lamps, table legs, around which the robotic cleaning device must navigate as well as rugs, carpets, doorsteps, etc., that the robotic cleaning device 100 must traverse. The robotic cleaning device 100 is hence configured to learn about its environment or surroundings by operating/cleaning.

Hence, the 3D sensor system comprising the camera 123 and the first and second vertical line lasers 127, 128 is arranged to record images of a vicinity of the robotic cleaning from which objects/obstacles may be detected. The controller 116 is capable of positioning the robotic cleaning device 100 with respect to the detected obstacles and a surface to be cleaned by deriving positional data from the recorded images. From the positioning, the controller 116 controls movement of the robotic cleaning device 100 by means of controlling the wheels 112, 113 via the wheel drive motors 115a, 115b, across the surface to be cleaned.

The derived positional data facilitates control of the movement of the robotic cleaning device 100 such that cleaning device can be navigated to move very close to an object, and to move closely around the object to remove debris from the surface on which the object is located. Hence, the derived positional data is utilized to move flush against the object, being e.g. a chair, a table, a sofa, a thick rug or a wall. Typically, the controller 116 continuously generates and transfers control signals to the drive wheels 112, 113 via the drive motors 115a, 115b such that the robotic cleaning device 100 is navigated close to the object.

It should further be noted that while this embodiment of the invention is discussed in the context of using a camera and one or two line lasers for illuminating a surface over which the robotic cleaning device 100 moves, it would further be possible to use known 3D sensors utilizing time of flight measurements of an image being completely illuminated.

As is understood, in the more complex robotic cleaning device 100 discussed with reference to FIG. 6, where objects are detected by interpreting sensor input in the form of captured images, and a representation of an environment of the robotic cleaning device 100 is created accordingly based on the sensor input, the method of controlling movement of the robotic cleaning device moo described in detail with reference to FIGS. 1-5 may still be implemented; if the robot 100 creates an erroneous representation of its surroundings, it is advantageous to determine whether the movement along said path comply with an expected movement or not.

It is further envisaged that a combination of distance, time period and angle can be utilized for determining whether robot movement along a path should be terminated.

The invention has mainly been described above with reference to a few embodiments. However, as is readily appreciated by a person skilled in the art, other embodiments than the ones disclosed above are equally possible within the scope of the invention, as defined by the appended patent claims.

1. A method of controlling movement of a robotic cleaning device, the method comprising:
determining a path to be traversed by robotic cleaning device;
controlling movement of the robotic cleaning device along the path;
determining whether the movement along the path does not comply with an expected movement; and if so:
terminating the movement along the path.

2. The method according to claim 1, wherein determining whether the movement along the path does not comply with the expected movement comprises:
determining whether the robotic cleaning device has travelled along the path for a determined distance.

3. The method according to claim 1, wherein determining whether the movement along the path does not comply with the expected movement comprises:
determining whether the robotic cleaning device has travelled along the path for a determined time period.

4. The method according to claim 1, wherein determining whether the movement along the path does not comply with the expected movement comprises:
determining whether the robotic cleaning device has rotated a determined angle.

5. The method according to claim 1, further comprising:
creating a representation of an environment of the robotic cleaning device based on sensor input; wherein the path to be traversed by the robotic cleaning device is determined on the basis of the created representation.

6. The method according to claim 5, wherein the representation is created from objects detected in a vicinity of the robotic cleaning device.

7. A robotic cleaning device comprising:
a propulsion system configured to move the robotic cleaning device over a surface to be cleaned;
at least one obstacle detecting device configured to detect objects in a vicinity of the robotic cleaning device; and
a controller configured to control the propulsion system to move the robotic cleaning device and to acquire information from the at least one obstacle detecting device regarding detected objects; the controller further being configured to:
determine a path to be traversed by the robotic cleaning device;
control movement of the robotic cleaning device along the path;
determine whether the movement along the path does not comply with an expected movement; and if so:
terminate the movement along the path.

8. The robotic cleaning device according to claim 7, the controller further being configured to, when determining whether the movement along the path does not comply with the expected movement:
determine whether the robotic cleaning device has travelled along the path for a determined distance.

9. The robotic cleaning device according to claim 7, the controller further being configured to, when determining whether the movement along the path does not comply with the expected movement:
determine whether the robotic cleaning device has travelled along the path for a determined time period.

10. The robotic cleaning device according to claim 7, the controller further being configured to, when determining whether the movement along the path does not comply with the expected movement:
determine whether the robotic cleaning device has rotated a determined angle.

11. The robotic cleaning device of claim 7, wherein the obstacle detection device comprises a vision based sensor system.

12. The robotic cleaning device according to claim 11, wherein the vision based sensor system comprises:
a camera device configured to record images of a vicinity of the robotic cleaning device; and
a first line laser and a second line laser configured to illuminate the vicinity of the robotic cleaning device;
the controller further being configured to create a representation of an environment of the robotic cleaning device based on the recorded images; wherein the path to be traversed by the robotic cleaning device is determined on the basis of the created representation.

13. The robotic cleaning device according to claim 12, the controller further being configured to create the representation from objects detected in the recorded images.

14-15. (canceled)

16. The method according to claim 2, wherein determining whether the movement along the path does not comply with the expected movement further comprises:
determining whether the robotic cleaning device has travelled along the path for a determined time period.

17. The method according to claim 16, wherein determining whether the movement along the path does not comply with the expected movement further comprises:
determining whether the robotic cleaning device has rotated a determined angle.

18. The robotic cleaning device according to claim 8, the controller further being configured to, when determining whether the movement along the path does not comply with the expected movement:
determine whether the robotic cleaning device has travelled along the path for a determined time period.

19. The robotic cleaning device according to claim 18, the controller further being configured to, when determining whether the movement along the path does not comply with the expected movement:
determine whether the robotic cleaning device has rotated a determined angle.
